(19) United States
(12) Patent Application Publication
(10) Pub. No.: US 2018/0329963 A1
(43) Pub. Date: Nov. 15, 2018

(54) Embedded Analytics and Transactional Data Processing

(71) Applicant: SAP SE, Walldorf (DE)

(72) Inventors: Emil Voutta, Heidelberg (DE); Kai Richter, Muhltal (DE); Anja Wipfler, Karlsruhe (DE); Jörg Franke, Bruchsal (DE); Manfred Crumbach, Wiesloch (DE); Thomas Fleckenstein, Frankenthal (DE); Stefan Kraus, Bruchsal (DE); Sandeep R S, Bengaluru (IN); Andreas Balzar, Bad Schonborn (DE)

(21) Appl. No.: 15/590,810

(22) Filed: May 9, 2017

(51) Int. Cl. G06F 17/30; G06Q 10/06

(52) U.S. Cl. CPC G06F 17/30554; G06F 17/30522; G06T 11/206; G06Q 10/06393; G06Q 10/063114; G06F 17/30867

(57) ABSTRACT

Disclosed herein are system, method, and computer program product embodiments for an embedded analytics and transactional data processing system. An embodiment operates by receiving selection of a filter that indicates a subset of transactional data from a database to be displayed via an interface. Analytical data associated with the subset of transactional data is determined. Via the interface, the filter selection, the analytical data, and the subset of transactional data are all provided.

### BACKGROUND

As data sets increase in size, maintaining an understanding of the increasingly large data sets can be difficult for a user. Most database systems collect data in real-time. Because analytics on and about the data consumes substantial processing power, a second system (other than the database system) often handles analytics. This second system accesses the collected data and provides general analytics to the user. However, in the meantime, the collected data may have been changed or been updated in the database. Such changes may not have been reflected in the analytics until they are recomputed or reprocessed by the second system. As a result, at times, the user may only have access to an incomplete view of the data and the analytics.

### BRIEF DESCRIPTION OF THE DRAWINGS

The accompanying drawings are incorporated herein and form a part of the specification.

FIG. 1 is a block diagram showing example operations of an embedded analytics and transactional data processing system, according to some embodiments.

FIG. 2 is an example trans-analytics interface (TAI), according to an example embodiment.

FIGS. 3A-3F illustrate example configurations for a TAI, according to some embodiments.

FIGS. 4A-4F illustrate example operations of a TAI, according to some example embodiments.

FIG. 5 is a flowchart illustrating a process for an embedded analytics and transactional data processing system, according to some embodiments.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing an embedded analytics and transactional data processing system.

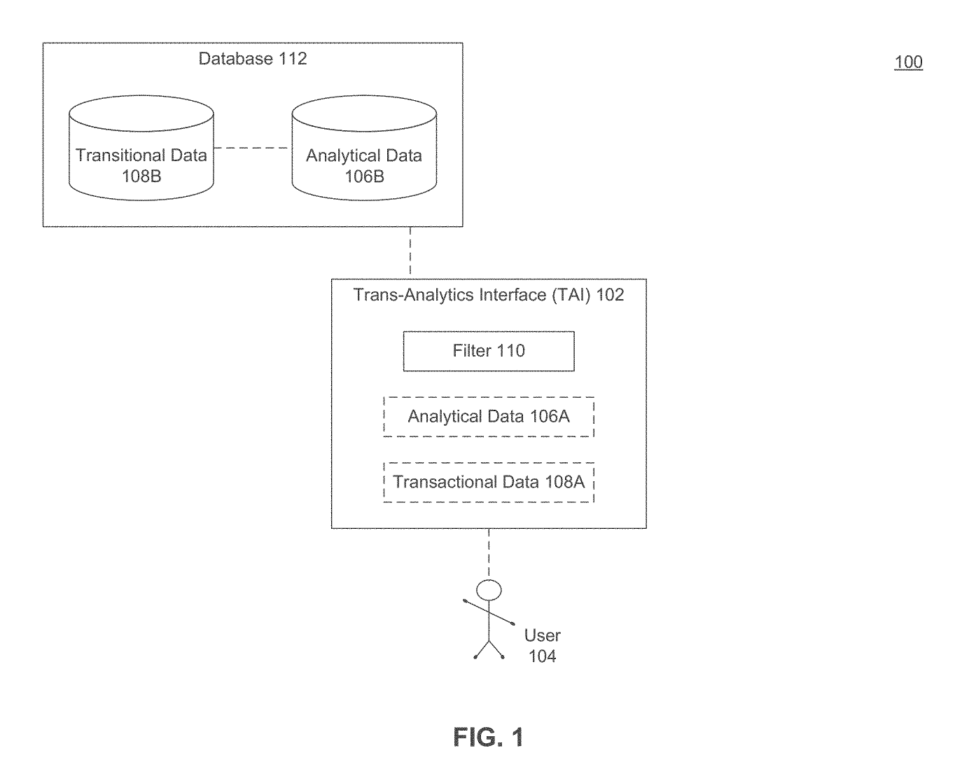

FIG. 1 is a block diagram showing example operations of an embedded analytics and transactional data processing system 100, according to some embodiments. A trans-analytics interface (TAI) 102 may provide a user 104 with the ability to filter 110, view, access, or modify analytical data 106A and transactional data 108A as may be retrieved from a database 112. In an embodiment, TAI 102 may provide this and other functionality from a single user interface 102 and in real-time. For example, changes to transactional data 108A may be immediately reflected in analytical data 106A without needing to retrieve a new set of data from database 112, or needing to perform an additional iteration of processing that may cause delays and consume additional resources. Database 112 and TAI 102 may be implemented in a single computer system, or distributed across multiple computer systems.

TAI 102 may allow a user 104 to see the interaction and relationships between analytical data 106A and transactional data 108A which meet the user's filter criteria 110. Transactional data 108 may include raw data captured by database 112 (e.g., as may be received from one or more mobile devices or applications interacting with database 112), such as ongoing sales transactions, employee compensation, payments received/made, etc. Analytical data 106 may include an aggregation, computation, transformation, or other processing performed on one or more portions of transactional data 108. According to some embodiments, when aggregation is referred to herein, it is understood that any other computation or transformation may be performed with or in lieu of the aggregation of data as part of the analytics.

In an embodiment, analytical data 106 may include a comparison or contrast of two or more sets of aggregated transactional data 108B. For example, filter 110 may indicate that user 104 wants to view the sales and expenses data of a particular project on which the user 104 is a manager. Then, for example, analytical data 106A may include the aggregated data for both sales and expenses for the selected project (e.g., chosen via filter 110), and may also provide or display a comparison of the aggregated selected project data against the aggregated data for one or more others projects (which may not have been selected) but may be associated with the selected or filtered project. For example, the other project may be another project on which user 104 is working, or that may be related to the same or similar client or industry.

In an embodiment, though analytics 106 may be provided for multiple selected and non-selected projects, TAI 102 may only include transactional data 108A corresponding to the selected project. As such, analytical data 106A may include the aggregation of transactional data 108A (which may be displayed on TAI 102) against a second aggregation of transactional data 108A (which may or may not be displayed on TAI 102).

As another example, analytical data 106A may include the profitability of a particular company across different time periods. However, the transactional data 108A for only a particular or selected one of the time periods may be displayed in TAI 102. Based on analytical data 106A and/or filters 110, user 104 may then select the most or least profitable time period to determine what transactions 108A contributed to that time period's profitability. Using TAI 102, user 104 may determine which transactional data 108 contributed to the performance of analytics of a particular project all within a single interface 102.

TAI 102 may enable an application or system (such as database system 112) to display data 108 at varying levels of granularity based on the various filters 110 and/or analytics 106 selected by a user 104, displaying information in a single interface that may otherwise require multiple interfaces or devices. TAI 102 enables a user to determine which transactional data 108 is relevant to producing the performance metrics or analytics 106 displayed, which may save processing cycles required to continually retrieve from database 112 to process the user 104's varying and multiple data requests. Any changes to the underlying transactional data 108A may then be displayed via TAI 102, thereby providing user 104 with a complete up-to-date view of the both transactional 108 and analytical 106 data.

As noted above, TAI 102 may enable user 104 to determine which data 106, 108 the user wants to access by setting up one or more filters 110 on the data. Filter 110 may include any selections which narrow data to be displayed on the interface of TAI 102. In an embodiment, filters 110 may correspond to different database tables, rows, columns, or other divisions or groupings of data (and may include reference to non-database stored data, such as data stored in a flat file). The corresponding data 108, 106 may then be retrieved or accessed from database 112 (or other storage location(s)), processed, and displayed. In an embodiment, database 112 may either be a row-oriented or column-oriented database, and may include either disk or memory storage.

Database 112 may be any data storage structure, device, or group of devices (e.g., such as the cloud or a server farm) from which transactional data 108B and/or analytical data 106B may be accessed or retrieved. Which data 106B, 108B of database 112 is accessed and displayed via TAI 102 may depend on which filters 110 a user 104 has configured and/or selected. In an embodiment, which data is displayed via TAI 102 or which filters 110 user 104 may access or configure may depend on a role of user 104. For example, a manager in the electronics division of a company may have different filters 110 and data access rights than an employee of the human resources division, which may be different from a CEO of the company. Example filters 110 may include a project or employee name, a date range, selected fields of data (e.g., name, contact information, sales), net sales, gross sales, client name, location, etc. Filters 110 may be applied to transactional data 108B and/or analytical data 106B.

Based on the selected or configured filters 110, TAI 102 may provide both transactional data 108A and corresponding analytical data 106A in real-time. TAI 102 may provide or display relationships between transactional data 108A and analytical data 106A. In an embodiment, user 104 may edit transactional data 108A directly from TAI 102 and immediately see how the change(s) affect analytical data 106A. Or, for example, as transactional data 108B is updated in database 112, those updates may be immediately pushed to or updated in TAI 102 (in real-time).

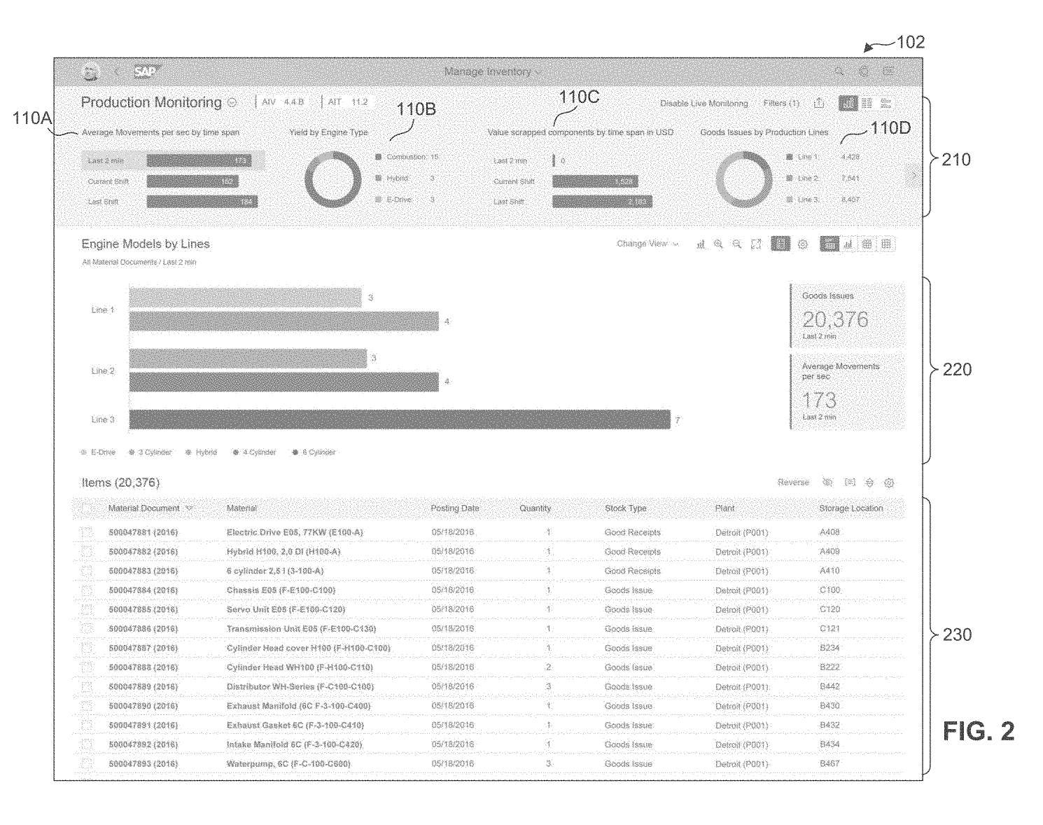

FIG. 2 is an example trans-analytics interface (TAI) 102, according to an example embodiment. In the example of FIG. 2, TAI 102 may include three sections, a filter section 210, analytics section 220, and a transactional data section 230. Though these are described as separate sections, it is understood that analytical data 106 and transactional data 108 may be displayed in any or across multiple sections. The example of FIG. 2 is only one embodiment of the TAI 102, and TAI 102 may have more or less than three sections.

Filter section 210 may include one or more filters 110A-D that have been selected, available to, or otherwise configured or configurable by a user 104. In the example shown, the filters 110A-D may be visual filters. Visual filters may provide a user the ability to configure or change the criteria by which user 104 wants to sort or filter data, and provide a preview of analytical data (106) that may correspond to or otherwise be associated with the filter selection(s) 110.

For example, filter 110B may indicate that a user has selected or is interested in data about different engine types being produced. Visual filter 110B, as shown in the example of FIG. 2, may include a visual chart or breakdown of the various engine types that are being manufactured or ordered. Chart 110B indicates that combustion engines make up the majority of the engine types. This may be interesting to a user who may be trying to figure out which engine type(s) to change to increase profitability. TAI 102 may indicate which information is the most interesting, impactful, or relevant to the user's query. For example, as shown, chart 110B may indicate that the transactional data 108 relating to combustion engines is likely the most impactful on the selected filters 110 or analytics 106.

Analytics section 220 may include analytical data 106A which may include a high level view or aggregation or other processing of transactional data 108A (as shown in transactional data section 230). In the example shown, analytics section 220 may indicate that there may be three different manufacturing or production lines for engines in a company. The analytical data 106A may show the differences in production outputs by the various lines.

Transactional data section 230 may include information about the actual engines that were produced or manufactured. The transactional data 108A shown may include at least a portion of the data used to compute the analytics shown in analytics section 220 and/or visual filters 110A-D. As shown, the various transactional data information that may have been selected for display includes the materials being used, the quantity, where the engines are being stored, etc.

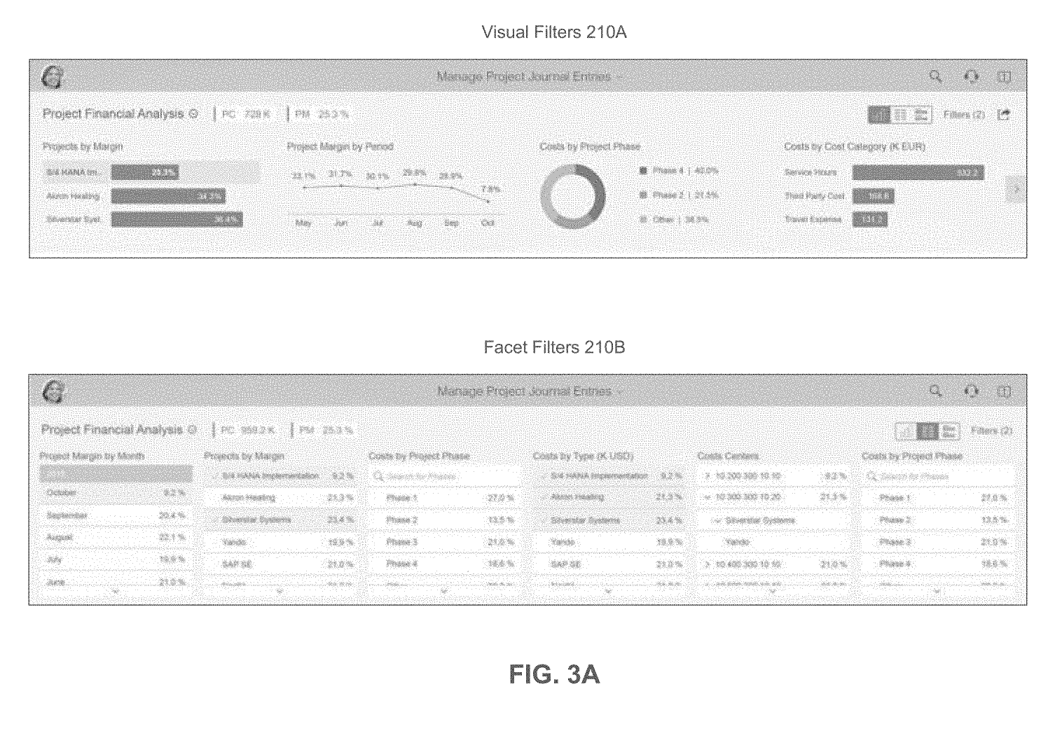

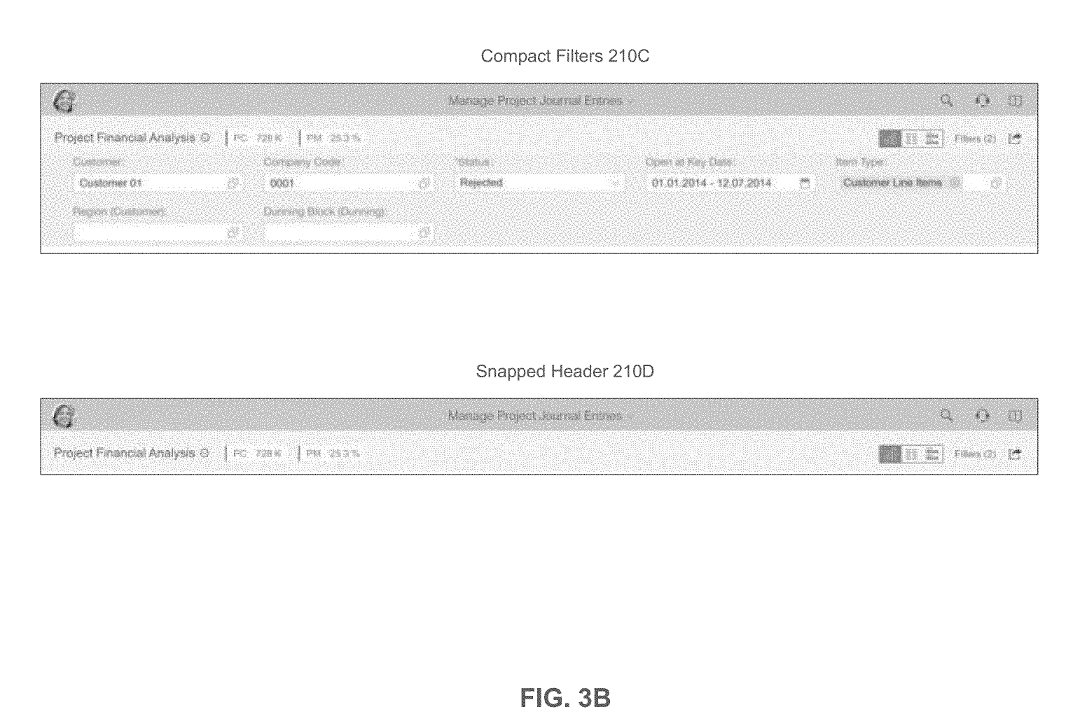

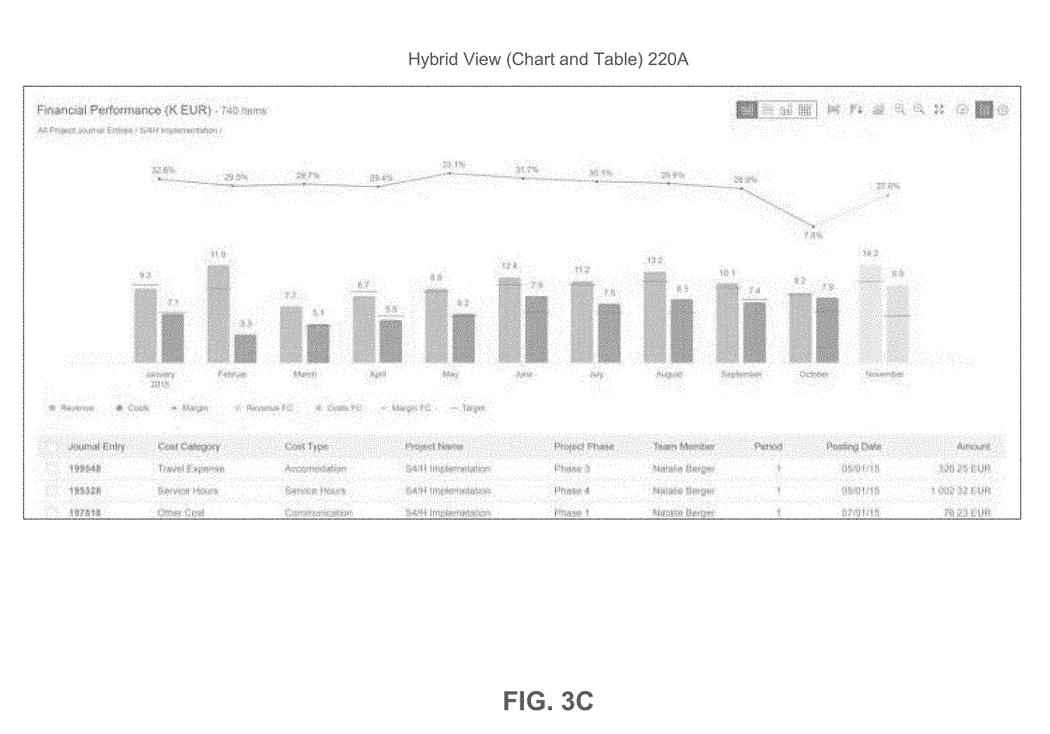

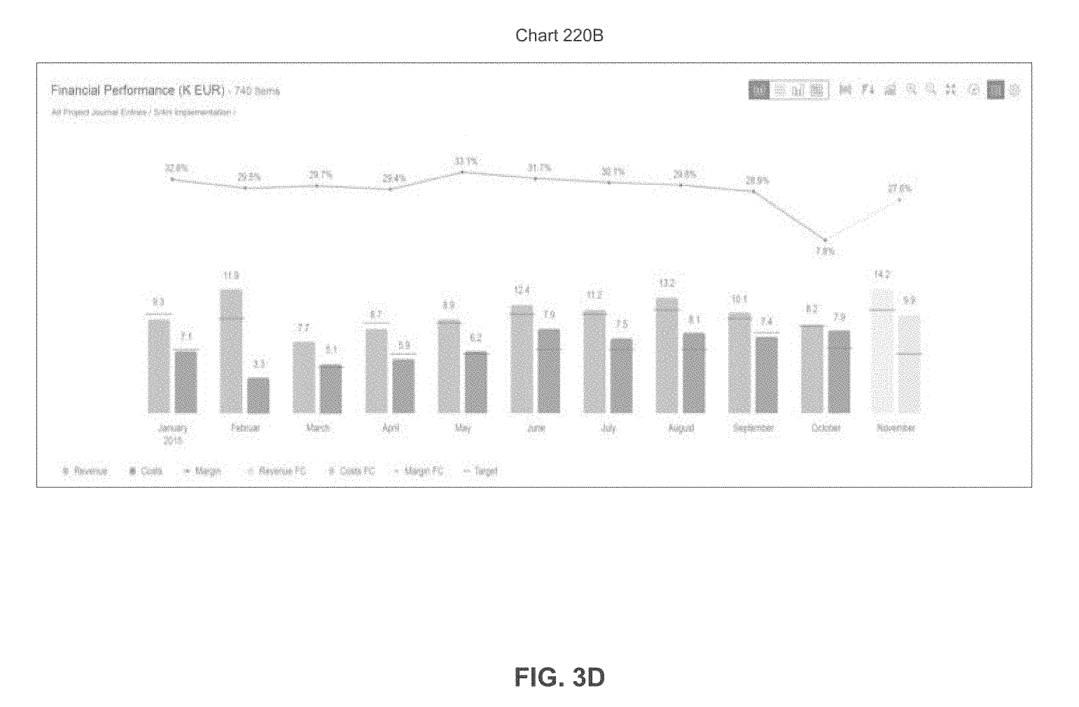

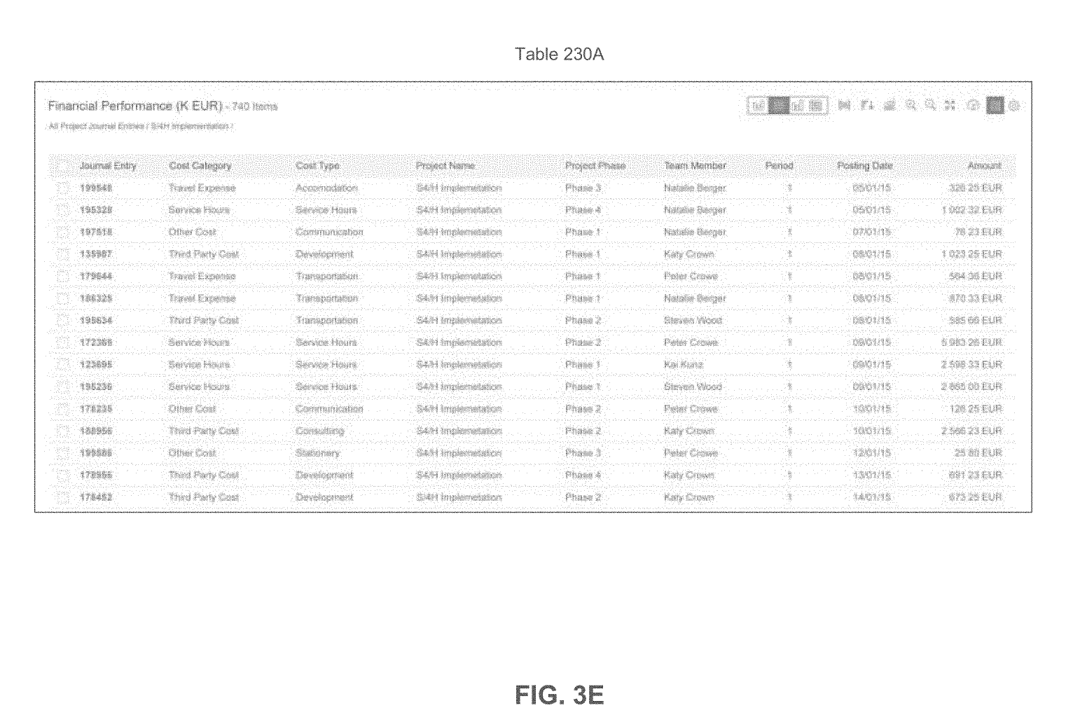

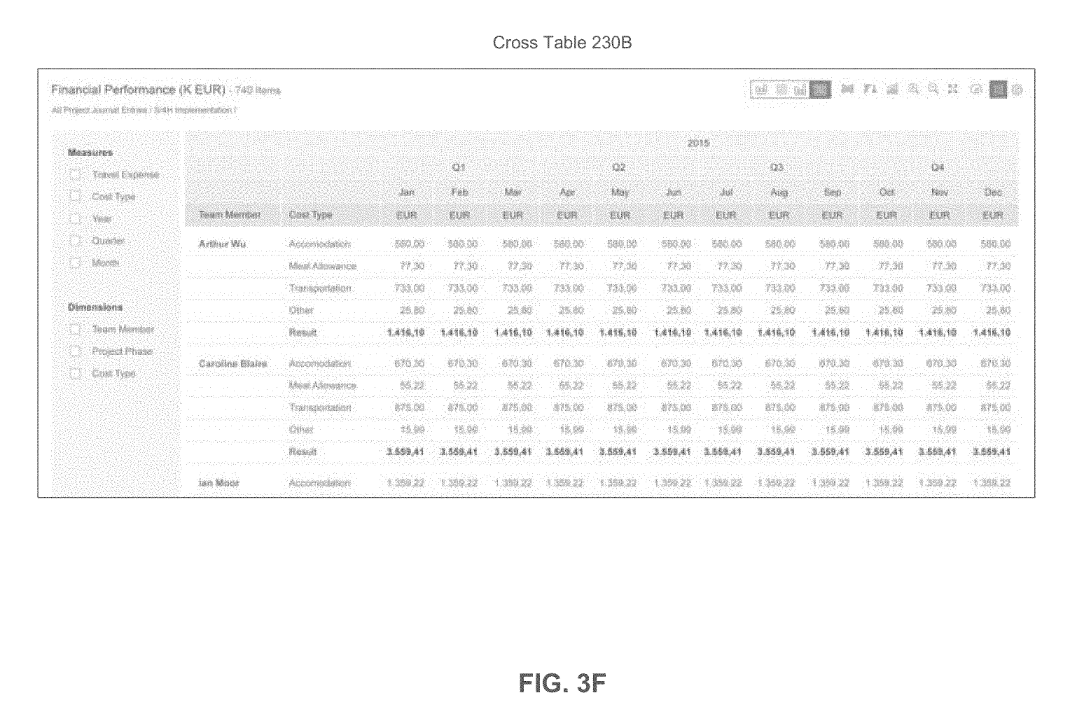

FIGS. 3A-3F show example configurations for the TAI 102, according to some embodiments. In an embodiment, TAI 102 provides a user 104 the ability to select from any or a combination of filters 210A-D as shown in FIGS. 3A-3B for use in a single interface.

Example visual filters 210A may include filters that enable a user 104 to preview analytical data corresponding to or associated with the selected or configured filter. In an embodiment, the analytical data displayed in a visual filter 210A may include a chart or graph that makes it easy to visually discern differences between different categories or aggregations of data. In an embodiment, a user may choose which data or which visual indicator (e.g., chart, graph etc.) is used in a visual filter 210A.

Facet filters 210B may enable a user to select which data or categories of data the user is interested in seeing aggregated (as analytical data) or for which the user is interested in seeing the corresponding or underlying transactional data. A facet filter 210B may provide a user the option of selecting one or more categories of available data or data values. For example, as shown, a user may select different projects and/or time periods from facet filter 210B. In an embodiment, a user 104 may make as many or as few selections from facet filters 210B as is applicable or useful for the user.

Compact filters 210C may enable a user to enter or select specific data or criteria for which the user is interested in viewing corresponding data. For example, the user may enter or select different information for which matching data from database 112 may be identified, searched, sorted, and displayed. In the example shown, the user may be interested in seeing only data for Customer 1 that has a status of being “Rejected.” In an embodiment, compact filter 210C may include a search element. For example, instead of Customer 1, the user may enter H*, thus returning data for those customers whose name begins with H.

In an embodiment, TAI 102 may include a snapped header 210D which enables a user to toggle on/off the filters or a display of the filters 210A-C. For example, once the filters 210A-C are set, a user may snap the header so there is more display area available for viewing or displaying the underlying or corresponding analytical data 106 and/or transactional data 108. Then, for example, if the user wants to see or modify the filter information 110, the user may unsnap the header 210D and expand the filter section 210.

In an embodiment, TAI 102 provides a user 104 the ability to select from any or a combination of views 220A, 220B, 230A, 230B for the analytical area 220 and transactional data area 230 as shown in FIGS. 3C-3F, for use in a single interface. These may be used in various combinations with the filters of FIGS. 3A-3B.

Views 220A, 220B, 230A and 230B shown in FIGS. 3C-3F are different examples of how a user 104 may choose to configure analytical section 220 and/or transactional data section 230 of TAI 102. Hybrid view 220A enables a user to choose to have analytics (analytical data 108A) displayed a chart and table view, while chart 220B displays analytical data as a chart or combination of charts.

In 230A and 230B (FIGS. 3E and 3F), the user may choose to have transactional data 106A displayed as a table 230A, or as a cross table 230B. A cross table 230B may be an intersection or union between two or more charts. Visual indicators, other than those shown, may be used for views 220, 230, although it should be noted that the embodiments shown are merely exemplary. For example, a pie graph may be used where appropriate or useful. Or, for example, analytical data may be displayed in a table or cross table view.

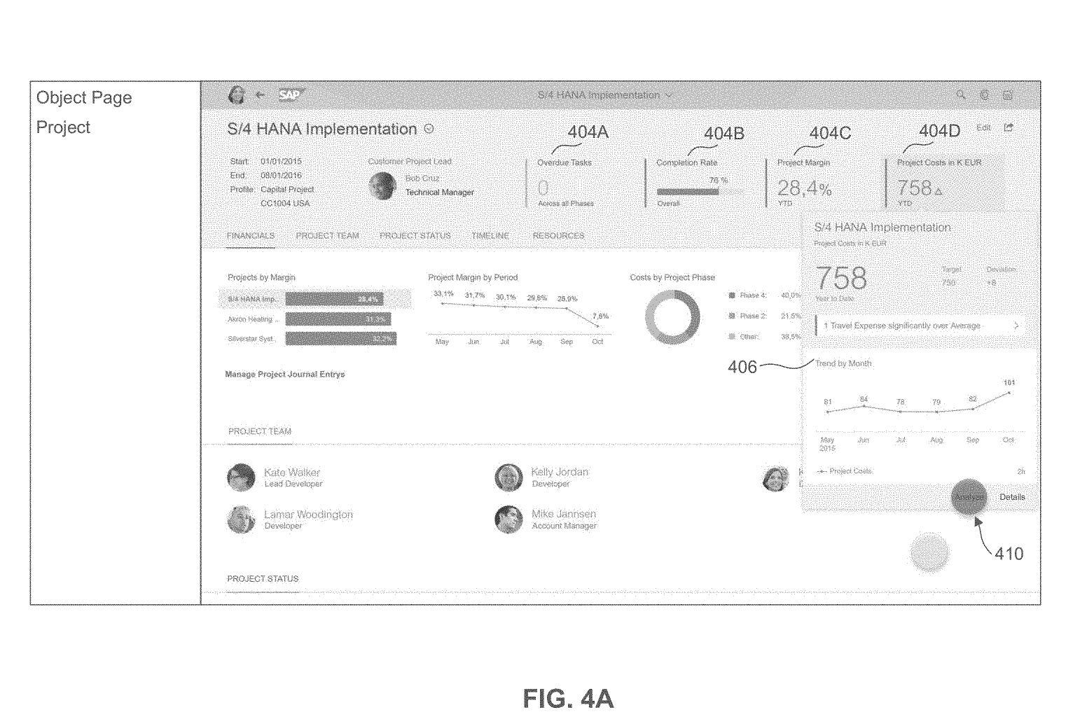

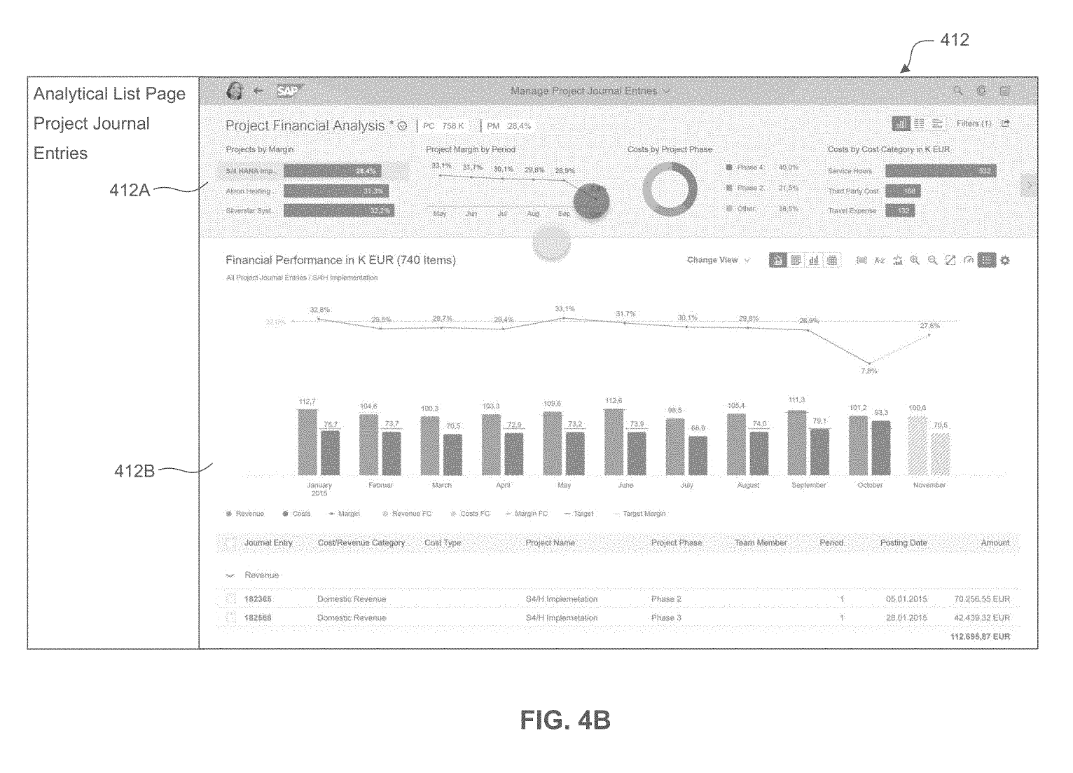

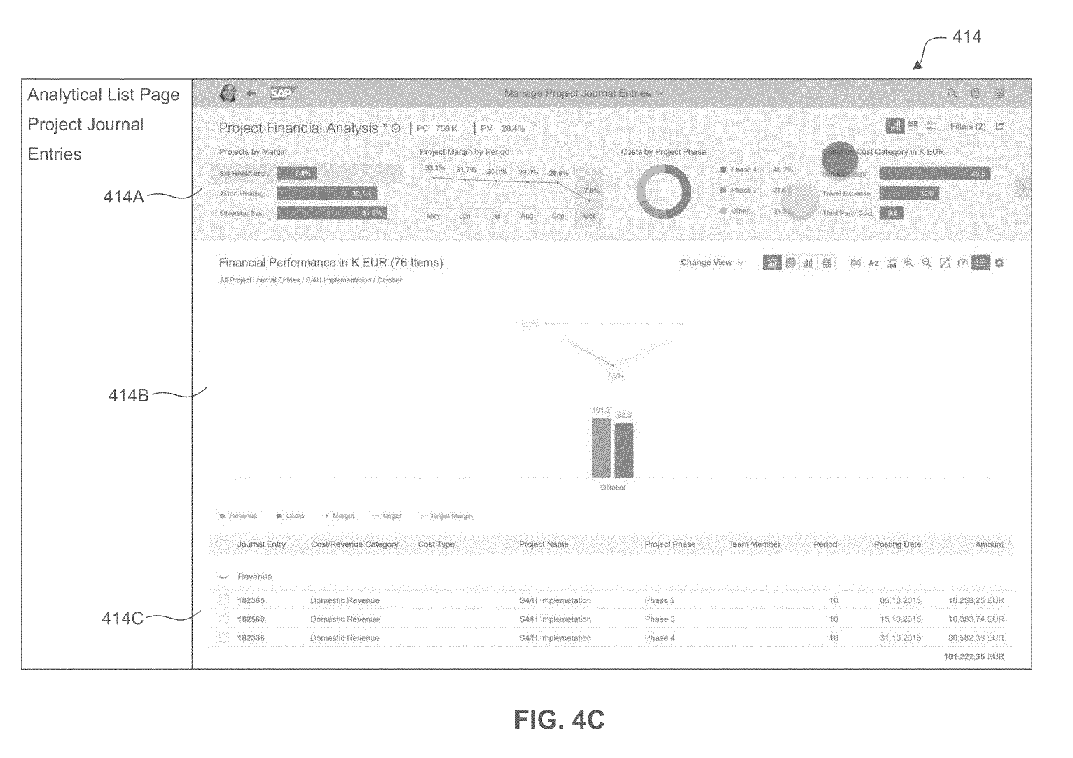

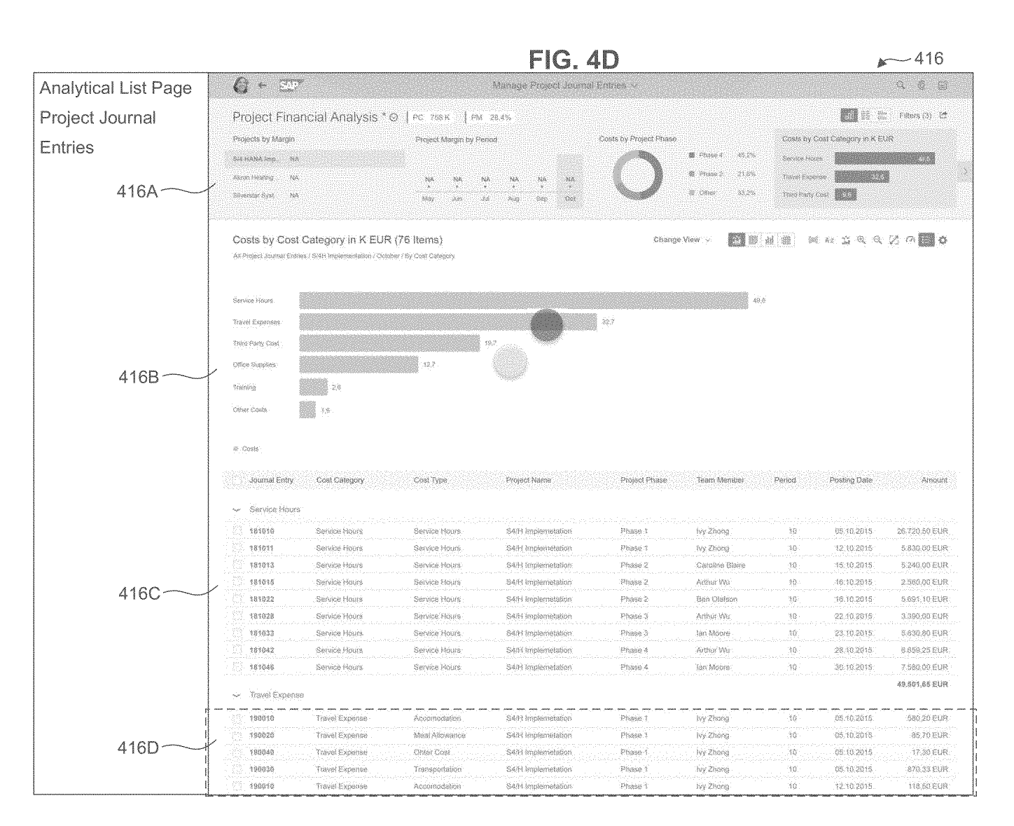

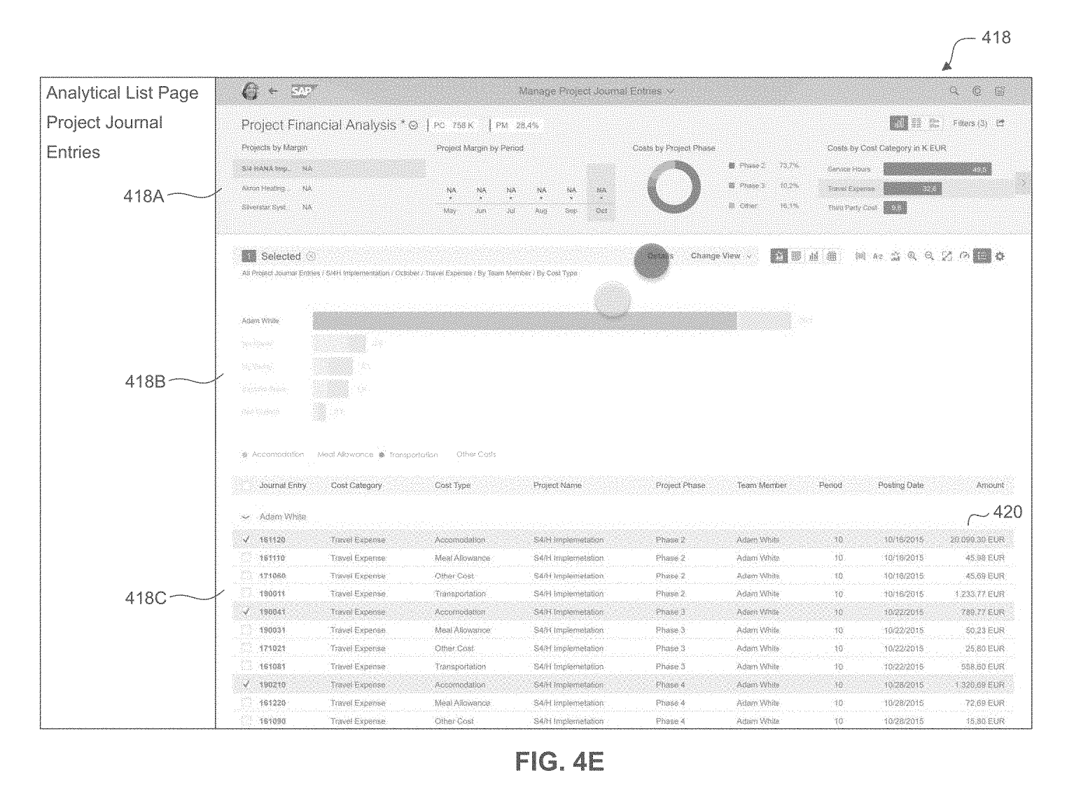

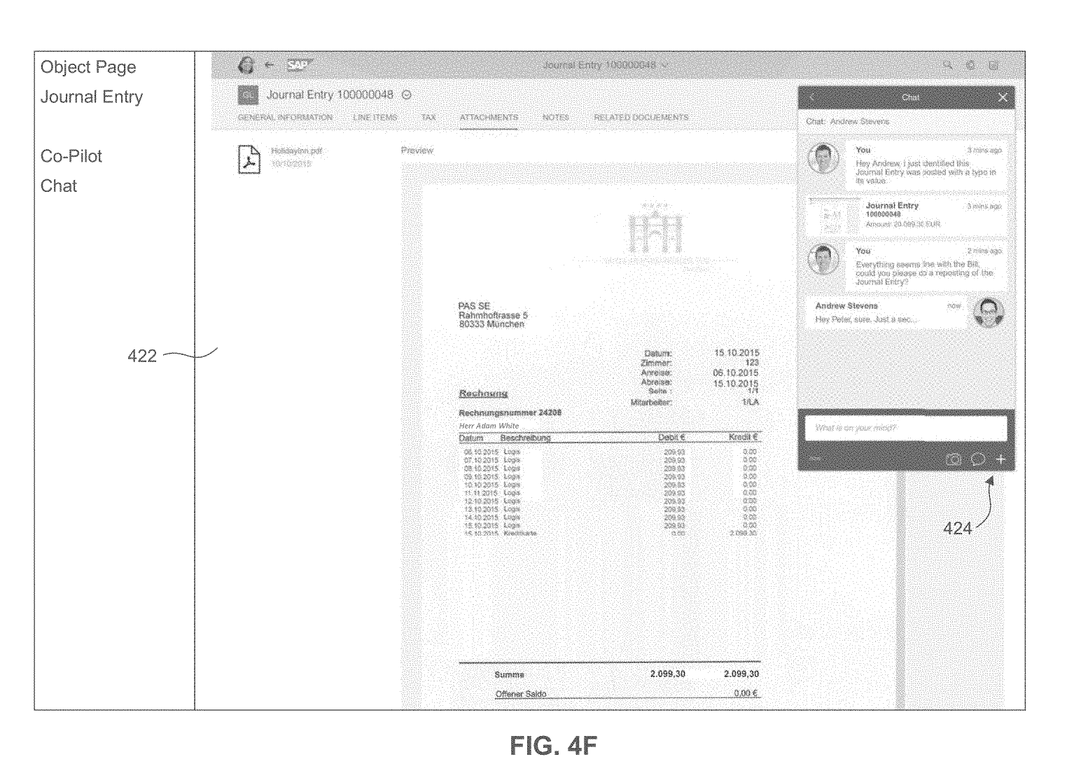

FIGS. 4A-4F show example operations of a TAI 102, according to some example embodiments. In FIG. 4A, various key performance indicators (404A-404D) are shown in the filter area 210 for a selected project. A key performance indicator 404 may be an analytic or data aggregation or computation that has been determined to be relevant for a selected set of data (e.g., the selected or filtered project). In the example shown, the indicators 404 may include, overdue tasks 404A, completion rate 404B, project margin 404C, and/or project costs 404D.

In an embodiment, key performance indicators may be provided relative to other non-selected data, such as other projects which may not have been selected by a user 104, but which may nonetheless be considered relevant to determining the status of the current project. For example, it may be helpful for a user 104 (manager) to see how the selected project is performing relative to past or other ongoing projects to determine where improvements can be made.

In an embodiment, PAI 102 may visually indicate when a performance indicator or analytic is outside of a predetermined normal range. For example, if the project costs are high (beyond a threshold), they may be shown in red or green or provided with another distinguishing visual indicator. If the analytics are approaching the threshold, they may be shown in another color, such as amber, or with other visually distinctive features.

A user 104 may then select the visual indicator 440D and see additional analytical data 406, such as costs broken down by time period and/or transactional data such as the various charges that make up the costs across one or more of the time periods. As may be seen in analytical data 406, the costs for October may be significantly higher than those of previous months and may be analyzed in greater detail. PAI 102 may provide additional data that make up the costs shown in 406 with the selection of an analyze button 410.

FIG. 4B shows an example of filters and analytical data in a TAI 412, according to an embodiment. For example, the screen of FIG. 4B may show financial analysis data related to the analyze selection 410 of FIG. 4A. In section 412A, various visual filters that may be default or configured by a user 104 are displayed, and in section 412B, analytical data for financial performance may be provided.

As may be determined from both the project margin visual filter (in 412A) and the journal entries (in 412B), there was a decrease in the performance in October. TAI 102 may flag this discrepancy with a visual indicator, and the user may select this time period to see transactional data corresponding to this timer period as shown in the example of FIG. 4C.

In FIG. 4C, the filters shown in section 414A and the analytics shown in 414B may be updated for the selected time period (relative to the filters and analytics shown in 412 of FIG. 4B). Further, TAI 414 may also include transactional data in section 414C corresponding to the selected time period.

FIG. 4D shows an example progression when a user selects costs by category filter from section 416A. The analytics in 416B are updated, as are the transactional data in sections 416C and 416D. The transactional data 416C, D may be broken down by cost type, corresponding to the analytics shown in 416B. As shown, a selection in section 416B of travel expenses causes TAI 416 to highlight the underlying transaction data 416D corresponding to the selected travel expenses in 416B.

In FIG. 4E, TAI 418 shows a further breakdown of the selected travel expenses (as selected from 416) by employee or team member. As can be seen in the analytics section 418B, the expenses for Adam White far outweigh the expenses by the rest of the team members. As such, a selection of Adam White from section 418B, may cause TAI 418 to highlight corresponding transactional data in section 418C (corresponding to the travel expenses of Adam White). Of particular relevance may be transactional data 420, which is much larger than the rest of the transactional data.

As shown in FIG. 4F, in an embodiment, a user 104 may select the entry 420 and TAI may provide interface 422. Interface 422 may show additional data, such as raw data, corresponding to selected transactional data 420. In the example shown, the actual expenses were only 2,099, and not 20,099. TAI indicates that the entry was a typo. Then user 104 may edit the entry directly, or may use another application 424, such as a messaging application to notify another party of the error. When the error is fixed, this change may be immediately reflected in the analytics described above with respect to FIGS. 4A-4E.

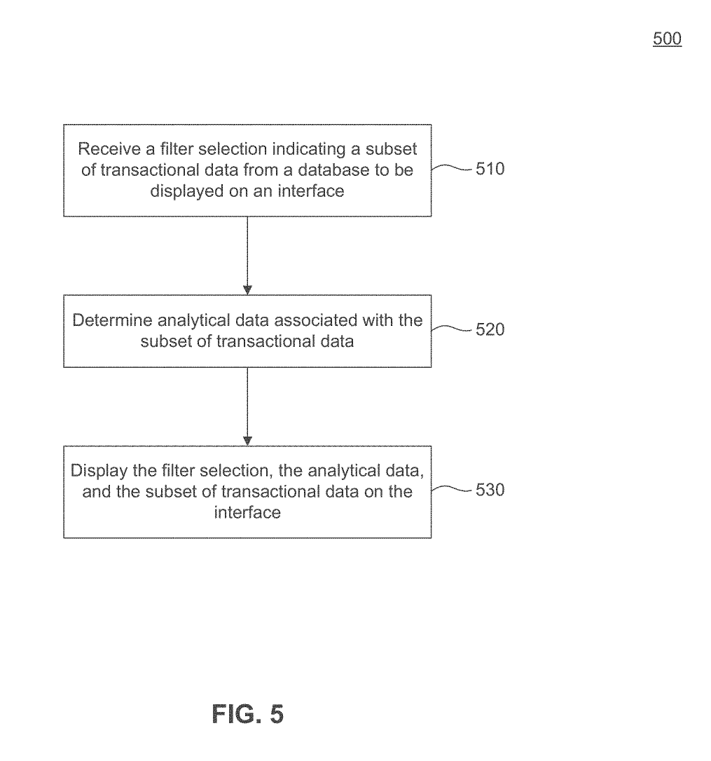

FIG. 5 is a flowchart illustrating a process 500 for embedded analytics and transactional data processing, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

At 510, a filter selection indicating a subset of transactional data from a database to be displayed on an interface is received. For example, a user 104 may select or configure any filter 110 to determine which data 106, 108 the user wants to see or evaluate from database 112. Filter 110 may include visual filters 210A, facet filters 210B, compact filters 210C, and/or snapped headers 210D as shown in FIGS. 3A-3B.

At 520, analytical data associated with the subset of transactional data is determined. For example, based on the configured or selected filters 110, TAI 102 may select analytical data 106B for display with the selected filter (e.g., visual filter 210A) or in an analytical data section 220 of TAI 102 (as shown in FIG. 2). As shown in FIGS. 4A-4D, the analytics provided may include aggregations or other computations performed on transactional data 108.

At 530, the filter selection, the analytical data, and the subset of transactional data are displayed on the interface. For example, as shown in FIG. 2 and FIGS. 4B-4D, TAI 102 may display filters, analytics, and corresponding transactional data. This may enable a user to quickly determine which transactional data was used to computer which analytics, and identify data errors, which may save processing cycles, time, and money.

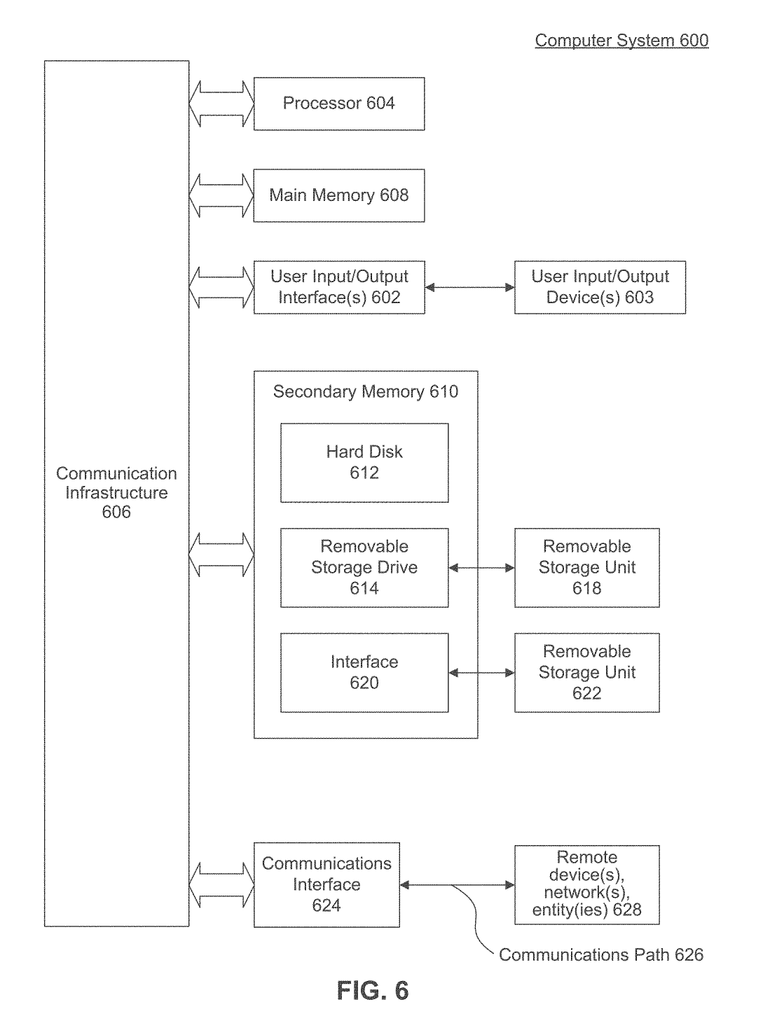

Various embodiments can be implemented, for example, using one or more computer systems, such as computer system 600 shown in FIG. 6. Computer system 600 can be used, for example, to implement the systems described above with respect to the figures, and/or the method of FIG. 5. Computer system 600 can be any computer capable of performing the functions described herein.

Computer system 600 can be any well-known computer capable of performing the functions described herein.

Computer system 600 includes one or more processors (also called central processing units, or CPUs), such as a processor 604. Processor 604 is connected to a communication infrastructure or bus 606.

One or more processors 604 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure 606 through user input/output interface(s) 602.

Computer system 600 also includes a main or primary memory 608, such as random access memory (RAM). Main memory 608 may include one or more levels of cache. Main memory 608 has stored therein control logic computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to an exemplary embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible apparatus or article of manufacture comprising a tangible computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
receiving, via an interface, a filter selection indicating a subset of transactional data from a database to be displayed on the interface;
determining analytical data associated with the subset of transactional data, wherein the analytical data comprises an aggregation of one or more portions of the transactional data; and
displaying the filter selection, the analytical data, and the subset of transactional data on the interface.

2. The method of claim 1, wherein the receiving comprises:
determining that the filter selection corresponds to a visual filter;
determining analytical data associated with the filter selection; and
displaying the visual filter on the interface, wherein the visual filter comprises a graphical representation of the filter selection and the analytical data associated with the filter selection.

3. The method of claim 1, wherein the database comprises the transactional data and the analytical data, wherein the analytical data corresponds to the transactional data.

4. The method of claim 1, further comprising:
receiving an analytics selection of at least a portion of the analytical data; and
displaying an indication on the interface responsive to the analytics selection, wherein the indication visually distinguishes a portion of the transactional data that corresponds to the analytics selection from a portion of the transaction data that does not correspond to the analytics selection.

5. The method of claim 4, further comprising:
receiving a modification to the indicated portion of the transactional data; and
updating the corresponding analytical data in real-time responsive to the modification.

6. The method of claim 1, wherein the displayed analytical data comprises data displayed in a chart, a table, or both the chart and the table, and wherein the displayed transactional data comprises at least a portion of the transactional data used to compute the provided analytical data organized in the table.

7. The method of claim 1, further comprising:
receiving a selection of the displayed analytical data, wherein the displayed analytical data comprises a performance indicator that indicates an aggregation of at least a first portion of transactional data stored in the database over a period of time and relative to an aggregation of a second portion of transactional data stored in the database; and
displaying the first portion of transactional data corresponding to the performance indicator responsive to the selection.

8. A system, comprising:
a memory; and
at least one processor of an in-memory database coupled to the memory and configured to:
receive, via an interface, a filter selection indicating a subset of transactional data from a database to be displayed on the interface;
determine analytical data associated with the subset of transactional data, wherein the analytical data comprises an aggregation of one or more portions of the transactional data; and
display the filter selection, the analytical data, and the subset of transactional data on the interface.

9. The system of claim 8, wherein to receive the at east one processor is configured to:
determine that the filter selection corresponds to a visual filter;
determine analytical data associated with the filter selection; and
display the visual filter on the interface, wherein the visual filter comprises a graphical representation of the filter selection and the analytical data associated with the filter selection.

10. The system of claim 8, wherein the database comprises the transactional data and the analytical data, wherein the analytical data corresponds to the transactional data.

11. The system of claim 8, wherein the processor is further configured to:
receive an analytics selection of at least a portion of the analytical data; and
display an indication on the interface responsive to the analytics selection, wherein the indication visually distinguishes a portion of the transactional data that corresponds to the analytics selection from a portion of the transaction data that does not correspond to the analytics selection.

12. The system of claim 11, wherein the processor is further configured to:
receive a modification to the indicated portion of the transactional data; and
update the corresponding analytical data in real-time responsive to the modification.

13. The system of claim 8, wherein the displayed analytical data comprises data displayed in a chart, a table, or both the chart and the table, and wherein the displayed transactional data comprises at least a portion of the transactional data used to compute the provided analytical data organized in the table.

14. The system of claim 8, wherein the processor is further configured to:
receive a selection of the displayed analytical data, wherein the displayed analytical data comprises a performance indicator that indicates an aggregation of at least a first portion of transactional data stored in the database over a period of time and relative to an aggregation of a second portion of transactional data stored in the database; and
display the first portion of transactional data corresponding to the performance indicator responsive to the selection.

15. A non-transitory computer-readable device having instructions stored on a memory thereon that when executed by at least one processor of the device, causes the at least one processor to perform operations comprising:
receiving, via an interface, a filter selection indicating a subset of transactional data from a database to be displayed on the interface;
determining analytical data associated with the subset of transactional data, wherein the analytical data comprises an aggregation of one or more portions of the transactional data; and
displaying the filter selection, the analytical data, and the subset of transactional data on the interface.

16. The device of claim 15, wherein the receiving comprises:
determining that the filter selection corresponds to a visual filter;
determining analytical data associated with the filter selection; and
displaying the visual filter on the interface, wherein the visual filter comprises a graphical representation of the filter selection and the analytical data associated with the filter selection.

17. The device of claim 15, wherein the database comprises the transactional data and the analytical data, wherein the analytical data corresponds to the transactional data.

18. The device of claim 15, wherein the operations further comprise:
receiving an analytics selection of at least a portion of the analytical data; and
displaying an indication on the interface responsive to the analytics selection, wherein the indication visually distinguishes a portion of the transactional data that corresponds to the analytics selection from a portion of the transaction data that does not correspond to the analytics selection.

19. The device of claim 18, wherein the operations further comprise:
receiving a modification to the indicated portion of the transactional data; and
updating the corresponding analytical data in real-time responsive to the modification.

20. The device of claim 15, wherein the displayed analytical data comprises data displayed in a chart, a table, or both the chart and the table, and wherein the displayed transactional data comprises at least a portion of the transactional data used to compute the provided analytical data organized in the table.
